(19) United States
(12) Patent Application Publication
(10) Pub. No.: US 2008/0287598 A1
(43) Pub. Date: Nov. 20, 2008

(54) Method of preparing aramid polymers incorporating carbon nanotubes

(76) Inventor: Kiu-Seung Lee, Midlothian, VA (US)

Correspondence Address: E I DU PONT DE NEMOURS AND COMPANY;LEGAL PATENT RECORDS CENTER, BARLEY MILL PLAZA 25/1122B, 4417 LANCASTER PIKE, WILMINGTON, DE, 19805, US

(21) Appl. No.: 11/605,541

(22) Filed: Nov. 29, 2006

(51) Int. Cl. C08L 77/10

(52) U.S. Cl. 524/538; 524/500; 977/742

(57) ABSTRACT

The invention relates to a method of preparing an aramid polymer solution having carbon nanotubes dispersed therein, providing a first dispersion comprising carbon nanotubes and a carrier polymer in a first solvent; providing a first solution comprising an aromatic diamine having an electron affinity lower than that of the carrier polymer and, optionally, a second solvent; adding the first solution to the first dispersion to form a second dispersion; adding an aromatic diacid or aromatic diacid chloride to the second dispersion; polymerizing the aromatic diacid or aromatic diacid chloride with the aromatic diamine to form a carbon nanotube containing aramid polymer or co-polymer in a first aramid solution; isolating the carbon nanotube-containing aramid polymer or co-polymer; and dissolving the carbon nanotube-containing aramid polymer or co-polymer in a third solvent to form a second aramid solution.

### FIELD OF THE INVENTION

The present invention relates to methods for the preparation of compositions comprising aramid polymer and carbon nanotubes, the resulting compositions and articles containing same.

### BACKGROUND OF THE INVENTION

Carbon nanotubes have elongated tubular bodies which are typically only a few atoms in circumference. These carbon nanotubes are hollow and typically have a linear fullerene structure. The length of the carbon nanotubes potentially may be thousands or millions of times greater than their diameter. Both single-walled carbon nanotubes and multi-walled carbon nanotubes are known in the art.

Carbon nanotubes are known to possess a unique combination of strength and weight, as well as electrical conductivity.

U.S. Pat. No. 6,872,403 discloses a synthetic resin made from a polymethylmethacrylate matrix and augmented with carbon nanotubes. The resin is said to be useful as a bone cement for joint prosthesis, dental prosthesis and/or dental restoration fixation in bone tissue.

### SUMMARY OF THE INVENTION

In one embodiment, the invention concerns a method of preparing an aramid polymer solution having carbon nanotubes dispersed therein, comprising:

providing a first dispersion comprising carbon nanotubes and a carrier polymer in a first solvent;

providing a first solution comprising an aromatic diamine having an electron affinity lower than that of the carrier polymer and, optionally, a second solvent;

adding the first solution to the first dispersion to form a second dispersion;

adding an aromatic diacid or aromatic diacid chloride to the second dispersion;

polymerizing the aromatic diacid or aromatic diacid chloride with the aromatic diamine to form a carbon nanotube containing aramid polymer or co-polymer in a first aramid solution;

isolating the carbon nanotube-containing aramid polymer or co-polymer;

dissolving the carbon nanotube-containing aramid polymer or co-polymer in a third solvent to form a second aramid solution.

The invention also relates to compositions made by the methods disclosed herein and to articles containing such compositions.

### DETAILED DESCRIPTION OF ILLUSTRATIVE EMBODIMENTS

In one embodiment, the invention concerns a method of preparing an aramid polymer solution having carbon nanotubes dispersed therein, comprising:

providing a first dispersion comprising carbon nanotubes and a carrier polymer in a first solvent;

providing a first solution comprising an aromatic diamine having an electron affinity lower than that of the carrier polymer and, optionally, a second solvent;

adding the first solution to the first dispersion to form a second dispersion;

adding an aromatic diacid or aromatic diacid chloride to the second dispersion;

polymerizing the aromatic diacid or aromatic diacid chloride with the aromatic diamine to form a carbon nanotube containing aramid polymer or co-polymer in a first aramid solution;

isolating the carbon nanotube-containing aramid polymer or co-polymer;

dissolving the carbon nanotube-containing aramid polymer or co-polymer in a third solvent to form a second aramid solution.

It should be noted that the first solution can comprise the aromatic diamine without any solvent being present. In other words, the “first solution” can be neat aromatic diamine. In some embodiments, however, the optional second solvent allows for better control of the addition of the aromatic amine to the first dispersion.

In some embodiments, the aromatic diamine comprises one or more of para-phenylene diamine, meta-phenylene diamine, 4,4′diphenyldiamine, 3,3′diphenyldiamine, 3,4′-diphenyldiamine, 4-4′-oxydiphenyldiamine, 3,3′-oxydiphenyldiamine, 3,4′-oxydiphenyldiamine, and 4,4′-sulfonyldiphenyldiamine and mixtures thereof.

Aromatic diacids and diacid chlorides include terephthalic acid, isophthalic acid, 2,6-naphthalenedicarboxylic acid, 2,6-naphthalenedicarboxylic acid chloride, isophthaloyl chloride, terephthaloyl chloride, and compounds of the formula:

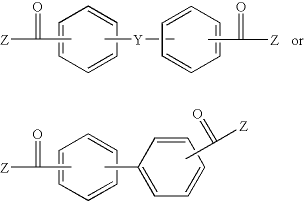

where Z is OH or Cl and Y is —O— or —SO₂—.

In some embodiments, the aromatic diacid or aromatic diacid chlorides are terephthalic acid, isophthalic acid, 2,6-naphthalenedicarboxylic acid, 4,4′-oxydibenzoic acid, 3,3′-oxydibenzoic acid, 4,4′-sulfonyldibenzoic acid, 3,3′-sulfonyldibenzoic acid, 3,4′-sulfonyldibenzoic acid, 4,4′-dibenzoic acid, 3,3′-dibenzoic acid, 3,4′-dibenzoic acid, and mixtures thereof. In addition, the diacid chloride analogs of the carboxylic acids can be utilized. These include 2,6-naphthalenedicarboxylic acid chloride, terephthaloyl chloride, isophthaloyl chloride, 4,4′-oxydibenzoyl chloride, 3,3′-oxydibenzoyl chloride, 4,4′-sulfonyldibenzoyl chloride, 3,3′-sulfonyldibenzoyl chloride, 3,4′-sulfonyldibenzoyl chloride, 4,4′-dibenzoyl chloride, 3,3′-dibenzoyl chloride, 3,4′-dibenzoyl chloride.

Some embodiments concern aramid polymer or co-polymer comprising para-phenylene diamine.

The carbon nanotubes can comprise single-walled or multi-walled carbon nanotubes, or mixtures thereof. In some embodiments, the carbon nanotubes comprise 50 to 100 percent multi-walled carbon nanotubes. In certain embodiments, the nanotubes incorporated into the polymer have an average aspect ratio greater than 100:1. In some embodiments, the average length of the carbon nanotubes is greater than 50 nanometers, and in some embodiments, greater than 100 nanometers. In certain embodiments, the carbon nanotubes are present in a concentration less than the percolation threshold.

Any solvents that perform within the requirements of the invention may be utilized. First and second solvents include, N-methyl-2-pyrrolidinone, N,N-dimethylacetamide, and/or N,N,N′,N′-tetramethylurea. Suitable third solvents include sulfuric acid and/or methanesulfonic acid. In some embodiments, the first and second solvent is N-methyl-2-pyrrolidinone and the third solvent is sulfuric acid.

In some embodiments, the aramid is poly(p-phenylene terephthalamide).

The invention also concerns a composition made by the methods described herein.

Other embodiments include articles comprising compositions made by the methods disclosed herein.

The present invention may be understood more readily by reference to the following detailed description and examples, which form a part of this disclosure. It is to be understood that this invention is not limited to the specific devices, methods, conditions or parameters described and/or shown herein, and that the terminology used herein is for the purpose of describing particular embodiments by way of example only and is not intended to be limiting of the claimed invention.

As used in the specification including the appended claims, the singular forms “a,” “an,” and “the” include the plural, and reference to a particular numerical value includes at least that particular value, unless the context clearly dictates otherwise. When a range of values is expressed, another embodiment includes from the one particular value and/or to the other particular value. Similarly, when values are expressed as approximations, by use of the antecedent “about,” it will be understood that the particular value forms another embodiment. All ranges are inclusive and combinable. When any variable occurs more than one time in any constituent or in any formula, its definition in each occurrence is independent of its definition at every other occurrence. Combinations of substituents and/or variables are permissible only if such combinations result in stable compounds.

The term “polymerizing” means the condensation of monomers to form a molecule of higher molecular weight than the monomers. One example of polymerizing is the reaction of an aromatic diacid chloride with an aromatic diamine to produce a material containing residues of both the aromatic diacid chloride and the aromatic diamine.

“Carrier polymer” is intended to mean a polymer that promotes the dispersion of the carbon nanotubes in the first solvent.

The term “dispersion”, as used herein, is a liquid or colloid containing dispersed particles.

As used herein, “electron affinity” is the energy change that occurs when a molecule gains an electron to form a negative ion.

By “percolation threshold” is meant the threshold concentration at which carbon nanotubes begins touch each other to make substantially continuous connection.

By “diacid chloride analog” of a diacid is intended to be a composition where the —CO₂H groups of the corresponding acid chloride are presented as —COCl. In some embodiments, the diacid chlorides are made from the diacids by methods known to those skilled in the art. These compounds, for example, can be prepared by reacting a carboxylic acid with thionyl chloride.

By “aramid” is meant a polyamide wherein at least 85% of the amide (—CO—NH—) linkages are attached directly to two aromatic rings. Suitable aramid fibers are described in Man-Made Fibers—Science and Technology, Volume 2, Section titled Fiber-Forming Aromatic Polyamides, page 297, W. Black et al., Interscience Publishers, 1968. Aramid fibers are, also, disclosed in U.S. Pat. Nos. 4,172,938; 3,869,429; 3,819,587; 3,673,143; 3,354,127; and 3,094,511. Additives can be used with the aramid solutions and it has been found that up to as much as 10 percent, by weight, of other polymeric material can be blended with the aramid or that copolymers can be used having as much as 10 percent of other diamine substituted for the diamine of the aramid or as much as 10 percent of other diacid chloride or diacid for the diacid chloride or diacid of the aramid.

One preferred aramid is a para-aramid and poly(p-phenylene terephthalamide) (PPD-T) is the preferred para-aramid. By PPD-T is meant the homopolymer resulting from approximately mole-for-mole polymerization of p-phenylene diamine and terephthaloyl chloride and, also, copolymers resulting from incorporation of small amounts of other diamines with the p-phenylene diamine and of small amounts of other diacid chlorides with the terephthaloyl chloride. As a general rule, other diamines and other diacid chlorides can be used in amounts up to as much as about 10 mole percent of the p-phenylene diamine or the terephthaloyl chloride, or perhaps slightly higher, provided only that the other diamines and diacid chlorides have no reactive groups which interfere with the polymerization reaction. PPD-T, also, means copolymers resulting from incorporation of other aromatic diamines and other aromatic diacid chlorides such as, for example, 2,6-naphthaloyl chloride or chloro- or dichloroterephthaloyl chloride or 3,4′-diaminodiphenylether.

Reference to “carbon nanotubes” includes both single walled and multi-walled species. In certain embodiments, the carbon nanotubes comprise about 50 to about 100 percent multi-walled carbon nanotubes

In some embodiments, the nanotubes have an aspect ratio greater than 100:1. In certain embodiments, the nanotubes have an average length of 100-10,000 nanometers.

Carbon nanotubes can be acquired from a variety of commercial sources. Various techniques for producing carbon nanotubes are known in the art. See for example, U.S. Pat. Nos. 5,753,088 and 5,482,601, the disclosures of which are hereby incorporated herein by reference. Three commonly used techniques for producing carbon nanotubes are laser vaporization, electric arc, gas phase techniques. In some embodiments, the carbon nanotubes can be made by a variety of techniques including, but not limited to (1) HipCo, (2) Laser oven technology, and (3) Chemical Vapor Deposition (CVD).

CVD techniques include laser vaporization techniques which use a pulsed laser to vaporize graphite to produce carbon nanotubes. See, for example, A. G. Rinzler et al, Appl. Phys. A, 1998, 67, 29. Typically, this technique produces nanotubes having a diameter of approximately 1.1 to 1.3 nanometers (nm).

Electric arc techniques produce carbon nanotubes using an electric arc discharge. Single-walled nanotubes can be made by an electric arc discharge in a helium atmosphere with the graphite anode filled with a mixture of metallic catalysts and graphite powder (Ni:Y;C), as described by C. Journet et al. in Nature (London), 388 (1997), 756. Also see, C. Journet and P. Bernier in Appl. Phys. A, 67, 1. Typically, such SWNTs are produced as close-packed bundles with the bundles having diameters ranging from 5 to 20 nm. Typically, singles walled carbon nanotubes are aligned in a two-dimensional periodic triangular lattice bonded by van der Waals interactions. The electric arc technique of producing carbon nanotubes is further described by. The average carbon nanotube diameter from this technique is typically approximately 1.3 to 1.5 nm and the triangular lattice parameter is approximately 1.7 nm.

The gas phase technique for making carbon nanotubes is typically more efficient than the laser vaporization and electric arc techniques. This technique, sometimes referred to as the HiPco™ process, produces carbon nanotubes utilizing a gas phase catalytic reaction. Which utilizes carbon monoxide under temperature and pressure conditions to create relatively high quantities of high-purity carbon nanotubes that are essentially free of by-products. The HiPco process is described in further detail by P. Nikolaev et al. in Chem. Phys. Lett., 1999, 313, 91.

Published U.S. Patent Application No. 20040266939 (also published as EPO Patent Application No. EP 1,359,121) discloses a method of dispersing carbon nanotubes in N-methyl-2-pyrrolidinone (NMP) solvent. In particular, the surface of the nanotube is functionalized by the use of non-wrapping functional polymers. The functional conjugated group is generally selected to enhance solubilization of the nanotube. Examples of rigid functional conjugated polymers include poly(aryleneethynylene)s and poly(3-decylthiophene). In some embodiments, the poly(aryleneethynylene) is a poly(phenyleneethynylene). Other examples of the functionalized non-wrapping polymers can be found in U.S. Patent Application No. 20040266939.

Suitable aromatic diacids and diacid chlorides include terephthalic acid, 2,6-naphthalenedicarboxylic acid chloride, isophthaloyl chloride, 4,4′-oxydibenzoyl chloride, 3,3′-oxydibenzoyl chloride, 4,4′-sulfonyldibenzoyl chloride, 3,3′-sulfonyldibenzoyl chloride, 3,4′-sulfonyldibenzoyl chloride, 4,4′-dibenzoyl chloride, 3,3′-dibenzoyl chloride, 3,4′-dibenzoyl chloride.

Aromatic diamines useful in the instant invention include para-phenylene diamine, meta-phenylene diamine, 4,4′diphenyldiamine, 3,3′diphenyldiamine, 3,4′-diphenyldiamine, 4-4′-oxydiphenyldiamine, 3,3′-oxydiphenyldiamine, 3,4′-oxydiphenyldiamine, and 4,4′-sulfonyldiphenyldiamine.

Carrier polymers include rigid conjugated polymers such as poly(aryleneethynylene) [PPE] and polyaryleneethynylene [PAE]

Solvents useful for dispersing carbon nanotubes with a carrier polymer include N-methyl-2-pyrrolidinone, N,N-dimethylacetamide (DMAC), N,N,N′,N′-tetramethylurea (TMU), N,N′-dimethylpropyleneurea (DMPU), and N,N′-dimethylethyleneurea (DMEU)

Solvents useful for dissolving the aromatic diamine include N-methyl-2-pyrrolidinone, N,N-dimethylacetamide (DMAC), N,N,N′,N′-tetramethylurea (TMU), N,N′-dimethylpropyleneurea (DMPU), and N,N′-dimethylethyleneurea (DMEU)

Solvents useful for dissolving the aramid containing aramid polymer or co-polymer include sulfuric acid and methanesulfonic acid.

The invention also relates to articles comprising the compositions described herein. These articles include fibers, films, powders, pulps, resins, etc.

### Example 1-5

### Preparation of Carbon Nanotube Dispersion

1 gram of multi-wall carbon nanotube was dispersed in 500 ml of NMP according to the procedure described in EP 1,359,121 (assigned to Zyvex Corporation)

### Preparation of PPD-T Polymer in the Presence of Dispersed CNT

Into a pre-dried reaction kettle (1 liter) equipped with basket stirrer and N₂ inlet and outlet, N-methyl-2-pyrrolidone (NMP) containing 8.3% of calcium chloride (solvent premix), p-phenylene diamine (PPD), and carbon nanotube dispersion (1 gram carbon nanotube in 500 ml of NMP) as specified in the Table 1.

The content was stirred at room temperature until all PPD particles are completely dissolved. And the mixture was cooled in ice-water bath to 5° C. First portion of terephthaloyl chloride (TCl) was added all at once and the mixture was stirred for 5 minutes. The second portion of TCl was added after the ice water bath was removed, and the mixture was stirred at high speed. The solution becomes very viscous in a few minutes and finally crumbed into small particles. Stirring was continued for 15 more minutes and the content was washed several times with water until the liquid shows neutral.

The resulting polymer crumb was dried in vacuum at 120° C. overnight. The inherent viscosity was measured and recorded in Table 1.

TABLE 1

| | | | Nanotube* | TCl | | | % |
|---|---|---|---|---|---|---|---|
| Example | Weight | PPD | (g) | 1^{st}(g) | 2^{nd}(g) | IV | CNT |
| 1 | 160 | 8.812 | 2 | 5.805 | 10.781 | 5.56 | 0.021 |
| 2 | 160 | 8.812 | 4 | 5.805 | 10.781 | 5.16 | 0.041 |
| 3 | 160 | 8.812 | 6 | 5.805 | 10.781 | 4.66 | 0.062 |
| 4 | 160 | 8.812 | 8 | 5.805 | 10.781 | 4.04 | 0.082 |
| 5 | 160 | 8.812 | 10 | 5.805 | 10.781 | 4.69 | 0.110 |

In Table 1, “Weight” is weight of the premix in grams. The premix contains 5.508% (w/w) PPD and 8.30% calcium chloride in NMP. PPD and Nanotube* are weights in grams. Nanotube* contains 2 grams of MWNT and 2 grams of PPE carrier polymers in 996 grams of NMP. “% CNT” is the weight percent of nanotube based on polymer weight.

“IV” is measured by the procedure described in U.S. Pat. No. 3,869,429, the disclosure of which is incorporated herein by reference. Inherent viscosity (I.V.) is defined by the equation:

I.V.=ln(ηᵣₑₗ)/c

where “c” is the concentration (0.5 grams of polymer in 100 ml of solvent) of the polymer solution and ηᵣₑₗ (relative viscosity) is the ratio between the flow time of the polymer solution and the solvent as measured at 30° C. The inherent viscosity values reported and specified herein are determined using concentrated sulfuric acid (95-98% (w/w)).

What is claimed:

1. A method of preparing an aramid polymer solution comprising:
providing a first dispersion comprising carbon nanotubes and a carrier polymer in a first solvent;
providing a first solution comprising an aromatic diamine having an electron affinity lower than that of the carrier polymer and, optionally, a second solvent;
adding the first solution to the first dispersion to form a second dispersion;
adding an aromatic diacid or aromatic diacid chloride to the second dispersion;
polymerizing the aromatic diacid or aromatic diacid chloride with the aromatic diamine to form a carbon nanotube containing aramid polymer or co-polymer in a first aramid solution;
isolating the carbon nanotube-containing aramid polymer or co-polymer;
dissolving the carbon nanotube-containing aramid polymer or co-polymer in a third solvent to form a second aramid solution.

2. The method of claim 1, wherein the aromatic diamine comprises a diamine selected from the list consisting of para-phenylene diamine, meta-phenylene diamine, 4,4′diphenyldiamine, 3,3′diphenyldiamine, 3,4′-diphenyldiamine, 4-4′-oxydiphenyldiamine, 3,3′-oxydiphenyldiamine, 3,4′-oxydiphenyldiamine, and 4,4′-sulfonyldiphenyldiamine and mixtures thereof.

3. The method of claim 1, wherein the aromatic diacid or diacid chloride comprises at least one of terephthalic acid, isophthalic acid, 2,6-naphthalenedicarboxylic acid, 2,6-naphthalenedicarboxylic acid chloride, isophthaloyl chloride, terephthaloyl chloride, or compounds of the formula: 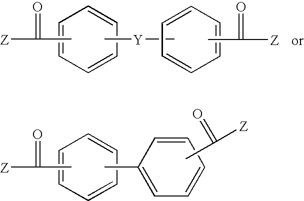
where Z is OH or Cl and Y is —O— or —SO₂—.

4. The method of claim 3 wherein the diacid or diacid chloride comprises at least one of terephthalic acid, isophthalic acid, 2,6-naphthalenedicarboxylic acid, 4,4′-oxydibenzoic acid, 3,3′-oxydibenzoic acid, 4,4′-sulfonyldibenzoic acid, 3,3′-sulfonyldibenzoic acid, 3,4′-sulfonyldibenzoic acid, 4.4′-dibenzoic acid, 3,3′-dibenzoic acid, 3,4′-dibenzoic acid, 2,6-naphthalenedicarboxylic acid chloride, terephthaloyl chloride, isophthaloyl chloride, 4,4′-oxydibenzoyl chloride, 3,3′-oxydibenzoyl chloride, 4,4′-sulfonyldibenzoyl chloride, 3,3′-sulfonyldibenzoyl chloride, 3,4′-sulfonyldibenzoyl chloride, 4,4′-dibenzoyl chloride, 3,3′-dibenzoyl chloride, and 3,4′-dibenzoyl chloride.

5. The method of claim 1, wherein the aramid polymer or co-polymer comprises para-phenylene diamine.

6. The method of claim 1, wherein the carbon nanotubes comprise 50 to 100 percent multi-walled carbon nanotubes.

7. The method of claim 1, wherein the first and second solvents are N-methyl-2-pyrrolidinone, N,N-dimethylacetamide, or N,N,N′,N′-tetramethylurea.

8. The method of claim 1, wherein the nanotubes incorporated into the polymer have an average aspect ratio greater than 100:1.

9. The method of claim 1, wherein the average length of the carbon nanotubes is greater than 50 nanometers.

10. The method of claim 1, wherein the carbon nanotubes are present in a concentration less than the percolation threshold.

11. The method of claim 1, wherein the third solvent is sulfuric acid or methanesulfonic acid.

12. The method of claim 1, wherein the first and second solvents are n-methyl-2-pyrrolidinone and the third solvent is sulfuric acid.

13. The method of claim 1 wherein the aramid is poly(p-phenylene terephthalamide).

14. A composition made by the method of claim 1.

15. The composition of claim 14 wherein the aramid is poly(p-phenylene terephthalamide).

16. The composition of claim 14 wherein the aromatic diacid is terephthalic acid.

17. The composition of claim 14 wherein the aromatic diamine is para-phenylene diamine.

18. The composition of claim 14 wherein the aromatic diacid is terephthalic acid and the aromatic diamine is para-phenylene diamine.

19. The composition of claim 14 wherein the carbon nanotubes have an average aspect ratio greater than 100:1

20. An article comprising a composition of claim 14.
